(19) United States
(12) Patent Application Publication
(10) Pub. No.: US 2022/0269944 A1
(43) Pub. Date: Aug. 25, 2022

(54) EVALUATION DEVICE FOR EVALUATING AN INPUT SIGNAL, AND CAMERA COMPRISING THE EVALUATION DEVICE

(71) Applicant: Robert Bosch GmbH, Stuttgart (DE)

(72) Inventors: Sven Rohr, München (DE); Christoph Burger-Scheidlin, Muenchen (DE)

(21) Appl. No.: 17/629,572

(22) PCT Filed: Jun. 9, 2020
(86) PCT No.: PCT/EP2020/065947

§ 371 Date: Jan. 24, 2022

(30) Foreign Application Priority Data
Jul. 26, 2019 (DE) 10 2019 211 116.5

(51) Int. Cl. G06N 3/08; G06N 3/04; G06V 10/82; G06V 20/52; G06V 40/16

(52) U.S. Cl. CPC G06N 3/082; G06N 3/0454; G06V 10/82; G06V 20/52; G06V 40/16

(57) ABSTRACT

An evaluation device for evaluating an input signal (7), wherein the evaluation device has a base network (11), wherein the base network (11) is produced by a machine learning system and has an input layer (2) and a boundary layer (13), wherein the input layer (2) and the boundary layer (13) have a plurality of layers (4) arranged between them that are connected by means of connections (6), wherein the base network (11) is trained for a basic purpose, having at least two special networks (12, 12a-12b), wherein the special networks (12, 12a-12b) each form a machine learning system and each have a special network input layer (14a, 14b) and a special network output layer (15a, 15b), wherein the special networks (12, 12a-12b) are each trained and/or trainable for a special purpose. The evaluation device is designed to carry out a method having the following steps:—receiving the input signal (7) and providing it to the input layer (2),—determining an intermediate signal with the base network (11) and providing it on the boundary layer (13),—taking the intermediate signal from the special network input layers (14a, 14b) of the at least two special networks (12, 12a-12b),—determining a respective special network output signal on the basis of the intermediate signal with the at least two special networks (12, 12a-12b) and providing it on the respective special network output layer (15a, 15b).

### BACKGROUND OF THE INVENTION

The invention relates to an evaluation device for evaluating an input signal, wherein the evaluation device is developed from a machine learning system that comprises an input layer and a boundary layer, with layers lying between them.

The document DE 20 2018 104 373 U1, which effectively represents the nearest prior art, describes a device for operating a machine learning system, in particular for controlling a calculation of the machine learning system. The device is designed to control the calculation of nodes within a graph of a neural network in a specific manner, so that only a small sequential dependency, if at all, occurs between the nodes.

### SUMMARY OF THE INVENTION

The object of the invention is to reduce the computing effort when operating a neural network when a plurality of analysis components are to be applied.

An evaluation device for evaluating an input signal according to the invention is proposed. A camera with the evaluation device according to the invention is furthermore proposed.

Preferred and/or advantageous embodiments result from the subsidiary claims, the description, and the appended figures.

An evaluation device for evaluating an input signal is proposed. The evaluation device can, for example, form a hardware module which can preferably be integrated as a chip system or module component into other devices and/or apparatus. The evaluation device is in particular designed for evaluating input signals of different types and/or by means of different analytical techniques. The input signal preferably here forms a data signal in a digital or analog form. It is particularly preferable that the input signal comprises an/or forms an image signal, for example a video or single image. Furthermore the input signal can, for example, form and/or comprise an audio signal or another type of sensor signal. The evaluation of the input signal is in particular designed as a computer-supported evaluation.

The evaluation device comprises a base network. The base network is, in particular, designed as a neural network and, in particular as a deep neural network. The base network comprises an input layer and a boundary layer. The input signal is, in particular, provided to the input layer and/or the input layer is designed to obtain the input signal. The input layer in particular forms a starting point for the processing of the machine learning system and/or of the neural network. The boundary layer can, in particular, be understood as the last layer of the machine learning system and/or of the base network. A plurality of layers, also known as hidden layers, are arranged between the input layer and the boundary layer. These are, in particular, referred to as hidden layers since normally only the input layer and the boundary layer, or a final layer, are visible to the user. The hidden layers each comprise nodes. The arrangement and/or the organization of the nodes is, in particular, critical for the layers. The nodes are connected to one another by edges. The nodes of one layer are, in particular, only connected to nodes of the previous or subsequent layers. In particular, the quantity of data reduces with increasing depth starting from the input layer as it passes through the evaluation device and/or through the base network in the direction of the boundary layer. The connections between the nodes and/or between the layers are also referred to as edges.

The base network is trained for a basic purpose. The basic purpose is, for example, a preprocessing of the image. In particular, the base network can be aimed at a basic image evaluation, for example in order to recognize characteristics and/or features, for example to group lines into polygons or objects. The training of the base network refers in particular to training for a concrete preprocessing, and/or is aimed at performing a concrete task. For example, a known input signal is and/or has been applied to the input layer for this purpose, wherein the network carries out a calculation and/or an evaluation on this and then performs an adaption to parameters of the processing of the nodes, also known as weights, in order to make the processing more precise. After a sufficient number of training passes, the neural network, in this case the base network, is also capable of processing images that have until now been unknown.

The evaluation device further comprises at least two special networks, preferably more than ten and in particular more than 100 special networks. The special networks are designed as machine learning systems and, in particular, as neural networks, preferably deep neural networks. The special networks are, in particular, independent of one another and are designed to have separate data. In particular, the special networks are designed differently, for example having different layer numbers. The special networks each comprise a special network input layer and a special network output layer. Multiple layers, in particular hidden layers, are preferably arranged between the special network input layers and the special network output layers. The layers between the special network input layer and the special network output layer in particular comprise multiple nodes. The special network input layer, nodes and special network output layer are connected to one another by edges, also known as connections.

The special networks are each trained for a special purpose. The special purposes are to be understood as evaluation and/or analytical tasks. The special purposes of the special networks preferably differ from one another. One special network is, for example, intended for one type of evaluation, while the other special purpose and/or special purposes are intended for different types of evaluation. The special purposes are, for example, object recognition tasks, tracking tasks and/or feature acquisition tasks. The special networks are trained and/or trainable, in particular by means of training data. This training, also known as learning, is in particular to be understood and/or designed as described for the training of the basic purpose of the base network, wherein only those parameters that are part of the special network can be adapted.

The evaluation device comprises at least one computing unit. The computing unit is, for example, designed as a computer, as a processor or microchip and/or comprises such an item. The computing unit is, in particular, designed to execute a computer program and/or program code of a computer program. The external device further comprises a storage medium, wherein the storage medium is designed to be machine readable. The storage medium forms, for example, a memory chip. Commands are stored on the machine-readable storage medium. The commands are, for example, designed and/or stored in the form of a computer program or as program code of a computer program. The execution of the commands that are stored on the storage medium by the at least one computing unit have the effect that a method is carried out with the steps of receiving the input signal and providing the input signal to the input layer, determining an intermediate signal with the base network, and providing the intermediate signal to the boundary layer.

The input signal can, for example, be received by being taken from an input interface, for example a cable or wireless interface. Multiple input signals can, in particular, also be received. The input signal is provided to the input layer. In particular the provision to the input layer is made in the form of an analog or digital signal. For example, the input signal is designed as an image file, wherein the image file is, for example, provided by a camera, wherein, for example, the image file is then provided for processing to the input layer.

The intermediate signal is in particular based on a processing of the input signal by the base network. The intermediate signal is, for example, the result of the processing of the input signal by the layers of the base network. The intermediate signal can, in particular, be thought of as the result of the processing of the input signal with the basic task and/or of the basic purpose. The intermediate signal is preferably then provided at the boundary layer and/or can be accessed and/or obtained from the boundary layer.

The intermediate signal is provided by the boundary layer to at least two of the special networks. The provision of the intermediate signal by the boundary layer takes place at the special network input layers of the at least two special networks. In particular, the provision of the intermediate signal can be made to more than two, for example to at least five or ten special networks and/or special network input layers. The special network input layers can for this purpose become and/or be connected in terms of data to the boundary layer of the base network. In particular, the special networks that are to be coupled and/or are coupled in terms of data to the base network are exchangeable; a coupled special network can, for example, be exchanged for and/or replaced by a different special network.

The execution of the commands that are stored on the storage medium and which result in performing the method referred to above further has the effect that the intermediate signal is taken up by the special network input layers and can, for example, be used for processing by the special network. The special network input signal is processed to create the special network output signal through the processing of the intermediate signal by the special network; this preferably takes place by means of the layers and/or through the application of the special purpose. In particular in this way at least two different special network output signals are generated, both of which are based on a common intermediate signal, wherein the intermediate signal already represents a processing of the input signal by means of a common machine learning system and/or neural network.

The invention is based on the idea of evaluating and/or analyzing an input signal by means of neural networks and/or of a machine learning system for different purposes and/or in different ways, wherein the evaluation takes place on the basis of a preprocessing of the input signal by a common base network. This has the advantage that the different processing and/or evaluations occur on the same and/or a common base network, so that a reduction in the computing effort can, for example, be generated in that calculations and/or analyses do not have to be carried out twice, but in common, once, by the base network. The provision of the intermediate signal to different analytical components, also referred to as special networks, on the basis of the base network can significantly reduce the computing effort of the evaluation. This is in particular achieved in that two evaluations of an input signal, once in a fundamental evaluation and once in a special evaluation are divided, wherein the fundamental evaluation is carried out by a common neural network and is, in particular, the same, while only the different special evaluations are carried out by separate neural networks.

It is optionally provided that the determinations of the special network output signals by means of the at least two special networks take place simultaneously. This can, for example, be understood to mean that the processing of the intermediate signal by the at least two special networks starts simultaneously, although they do not necessarily have to end simultaneously, for example if the computing effort for their performance differs. In particular, on the basis of the intermediate signal, a plurality of processing activities by different special networks to form the special network output signals can occur simultaneously. This configuration is based on the idea of being able to perform different evaluations of the input signals to form special network output signals simultaneously, and not necessarily having to carry them out sequentially, so that a processing of a different type, faster and requiring less computing power, is possible.

It is particularly preferred if the base network forms a pruned neural network. The base network in particular forms a pruned, deep, neural network. The pruned neural network is based on an unpruned original network. The original network refers, in particular, to a neural network, in particular a deep neural network, that comprises an input layer and an original network output layer, wherein, in particular, a plurality of layers with nodes and connections is arranged between these layers. It is in particular provided here that the input layer of the base network is the same as the input layer of the original network. The base network can be obtained from the original network, for example in that at least the original network output layer is and/or will be disconnected; other layers can furthermore also be and become pruned, in particular at the end of the original network. By cutting away these layers, the overall purpose of the original network is not achieved by the base network. The boundary layer of the base network is in particular formed by the last and/or finishing layer of the pruned neural network.

One embodiment of the invention provides that the evaluation device comprises at least one supplementary network. The supplementary network is, in particular, exchangeable and/or can be selected from a plurality of supplementary networks. The supplementary networks can be appended, exchanged and/or connected to a special network, in particular the special network output layer. The supplementary networks are, for example, trained for supplementary evaluations or tasks, for example for detail evaluations that are based on the special network output signals. In particular, a special network and/or a special network output layer can be and/or become connected to a plurality of supplementary networks so that, for example, tree structures of neural networks develop.

It is optionally provided that in one of the special networks the special network output layer simultaneously forms the special network input layer. This has, for example, the consequence that the intermediate signals output from this special network output layer are converted into the special network output signal directly, without a plurality of nodes located in layers and/or in between. Alternatively and/or in addition it can be provided that the special network output layer of one of the special networks forms the base network output layer for other special networks.

One embodiment of the invention provides that a plurality of special networks is stored on at least one of the storage media. For example, multiple and/or different special networks, for example more than ten or 100, are stored on the storage medium. The placement and/or storage of the special networks preferably takes place as an application, wherein, for example, a program component can be understood as an application. It is provided in particular that special networks can be selected from the applications by a user of the application as selected special networks. The selection can, for example, take place using a graphic user interface. The selection of the applications by the user is in particular based on the fact that the user wants to choose a desired evaluation as the special network to be used. The execution of the stored commands by the computing unit here has the effect that the method, or the steps of the method, are carried out with respect to the selected special network. An evaluation device that is particularly capable of change and adaptable to desired evaluations of the input signal can thus be provided.

In particular, it can be provided that the evaluation device comprises at least one first and one second computing unit. The first and the second computing unit are preferably separated spatially and/or as modules. It is, for example, provided that the first computing unit is designed, when carrying out the stored commands, to perform the steps of the method that relate to the processing of the input signal by the base network. The second computing unit is preferably here designed to perform those parts of the method that can be assigned to the processing of the intermediate signal by at least one of the special networks. This design is based on the idea of distributing the computing tasks and/or evaluations of the input signal to form the intermediate signal, and of the intermediate signal to form the special network output signals, to different computers.

It is particularly preferable that the second computing unit is designed as an external computing unit, in particular also referred to as an outsourced computing unit. The second computing unit can, for example, be designed as a cloud computer or as a cloud computer application. For example, the intermediate signals of the base network are provided and/or transmitted for this purpose to the cloud computer, wherein the processing of the intermediate signal by the special network takes place in the cloud computer. This has, for example, the advantage that a preprocessing of the input signal and/or reduction of the quantity of data can occur centrally and/or on site by means of the first computing unit, and the intermediate signal with a reduced quantity of data can be processed further externally.

It is in particular provided that the intermediate signal has a lower amount of data than the input signal. In particular the intermediate signal has a lower number of bits than the input signal. This is based on the consideration that the processing of the input signal into the intermediate signal leads to a reduction and/or preliminary evaluation, so that, for example, not all the pixels of an image have to be transmitted, but rather that the information is already oriented towards contours and/or features that are present.

It is particularly preferable that the intermediate signal is based on the input signal and comprises and/or describes features extracted from the input signal. Features in an image are, for example, associated elements, recognized edges, structures, shapes and/or concrete objects. This can, for example, be used in such a way that images and/or audio and video data do not have to be completely transmitted, but only the features extracted therefrom.

It is particularly preferred that the input signal comprises of and/or forms an image file. A single image can, for example, be understood as an image file; alternatively and/or in addition, the image file can comprise a sequence of images and/or a video file with image and audio information.

In particular it is provided that at least one of the special purposes is an image evaluation, a face and/or person recognition and/or a video surveillance. This embodiment is based on the idea of being able to provide special purposes, for example in surveillance cameras and/or surveillance installations, so that these can be operated with reduced computing power when the evaluation is operated using neural networks.

The special purposes and/or the special networks are, in particular, designed in different ways. This embodiment is based on the consideration that the special networks should fulfil different tasks and/or purposes, and should evaluate the input signal or the intermediate signal in different ways, so that the broadest possible evaluation of the input signal is possible.

A camera forms a further object of the invention. The camera is, for example, designed as a surveillance camera. The camera comprises the evaluation device described previously. The camera is designed to record images of a region under surveillance. The camera, for example, comprises a sensor element for this purpose, wherein the sensor element permits and/or provides optical recordings in the form of images of the region under surveillance. The images are provided to the evaluation device. The evaluation device is designed to use the provided images as the input signal. The evaluation device is designed to process the images, as the input signal, into the intermediate signal using the base network, and then to convert the intermediate signal into special network output signals with the at least two special networks. This design is based on the idea of providing a camera that enables a simultaneous evaluation of images by means of neural networks, wherein the computing power and/or computing effort are significantly reduced.

The invention furthermore relates to a method for evaluating an input signal, wherein a base network based on a machine learning system provides an intermediate signal to a boundary layer of the base network depending on the input signal, wherein the base network is trained for a basic purpose, wherein the intermediate signal is provided to at least two special networks based on a machine learning system at a respective special network input layer, wherein the special networks are each trained and/or trainable for a special purpose, wherein a respective special network output signal is determined on the basis of the intermediate signal using the at least two special networks, wherein the special network output signals are provided at the respective special network output layer. Preferably, a single base network provides an intermediate signal to a boundary layer of the base network depending on the input signal. Particularly preferably, the special output signals are determined simultaneously, and consequently in parallel, by means of the at least two special networks. Preferably, a first computing unit carries out the steps of the method for the base network, and a second computing unit carries out the steps of the method of at least one of the special networks. The method is, what is more, designed to perform the steps described with reference to the evaluation device.

The invention further relates to a computer program that is configured to perform all the steps of the described method, as well as a machine-readable storage medium, in particular a non-volatile machine-readable storage medium, on which the computer program is stored.

### BRIEF DECSRIPTION OF THE DRAWINGS

Further advantages, effects and embodiments of the invention emerge from the appended figures and their description. Here:

FIG. 1 schematically shows the application of a neural network to image processing;

FIG. 2 shows an exemplary embodiment of a base network with two special networks;

FIG. 3a shows a camera with an evaluation device as an exemplary embodiment;

FIG. 3b shows a further exemplary embodiment of an evaluation device with a camera.

### DETAILED DESCRIPTION

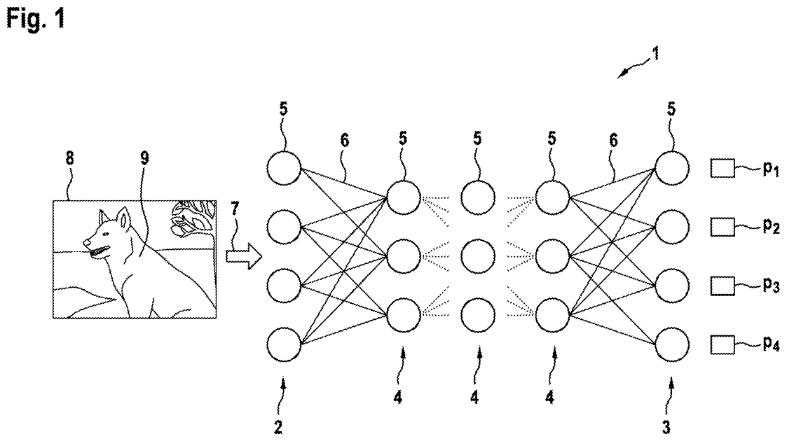

FIG. 1 schematically shows a neural network for image evaluation. The neural network 1 is in particular based on a machine-learning system. The neural network 1 comprises an input layer 2 and an output layer 3. A plurality of hidden layers 4 is arranged between the input layer 2 and the output layer 3. The hidden layers 4, the input layer 2 and the output layer 3 each comprise a plurality of nodes 5. The nodes 5 are connected to nodes 5 of an adjacent layer by means of connections 6, also known as edges.

An input signal 7 is/will be provided to the neural network 1. The input signal 7 is here configured as an image 8. The image 8 shows, in addition to a background, an animal 9, in this case a dog. The image 8 is provided as an input signal 7 to the input layer 2 and is processed and/or evaluated in the hidden layers 4. For example, relationships and/or features can be recognized and/or determined from individual pixels. The neural network 1 is a trained neural network, wherein the network has been trained by means of training data for the evaluation purposes.

The neural network 1 is trained in its evaluation for a purpose. The purpose, here, is for example determination of the type of animal. The neural network 1 for example outputs probabilities P₁, P₂, P₃ and P₄ in the output layer 3. The probabilities P₁ to P₄ each indicate the probability with which an animal type is present, for example the probability P₁ that a dog is recognized, P₂ that a mouse is recognized or P₃ that a fish is recognized. It is in particular also possible to output a rectangle with a recognized animal.

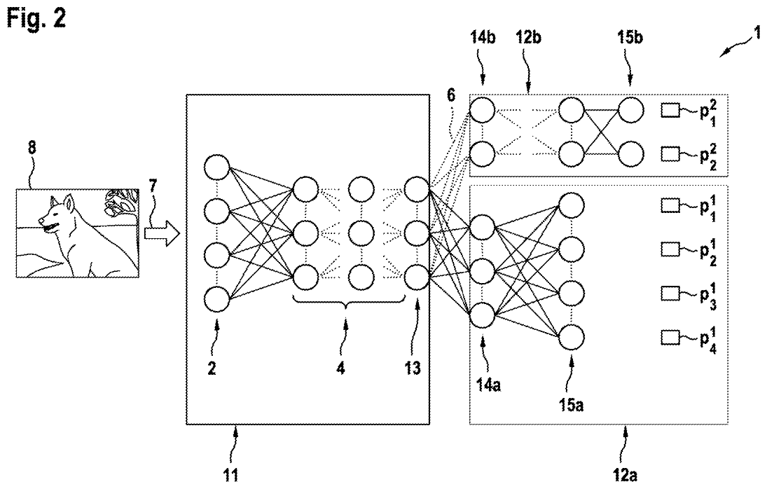

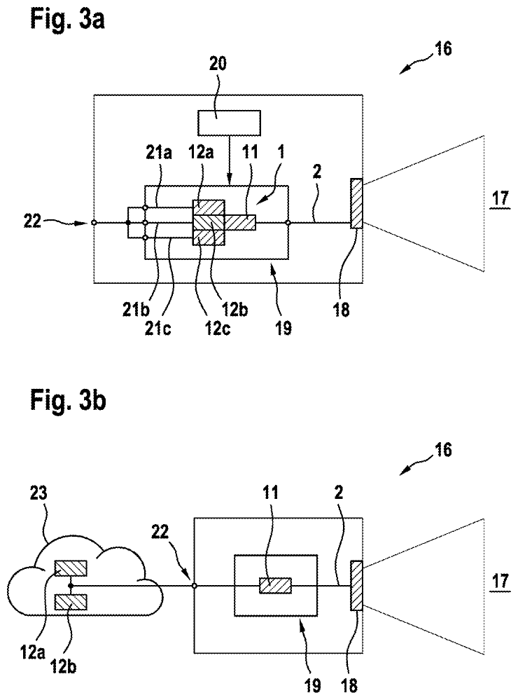

FIG. 2 schematically shows a neural network 1 comprising a base network 11, a first special network 12a and a second special network 12b. The special network 12a and the special network 12b are each connected in terms of data to the base network 11. The special network 12a and the special network 12b are in particular designed to be independent from one another in terms of data and/or be unconnected.

An input signal 7 is provided to the base network 11, wherein the input signal 7 comprises and/or describes the image 8. The input signal 7 is provided to an input layer 2 of the base network 11. Starting from the input layer 2, the input signal 7 is processed and/or evaluated in hidden layers 4, in particular on the basis of a basic purpose. The basic purpose can, for example, describe the analysis of the input signal 7 for features, for example image features. The base network 11 further comprises a boundary layer 13, wherein the boundary layer 13 comprises a plurality of nodes 5. The boundary layer 13 is, for example, designed like the layer 4a of FIG. 2. The base network 11 can, for example, be obtained by pruning a neural network 1 in which an output layer 3 is cut off.

The special network 12a as well as the special network 12b each respectively comprise a special network input layer 14a or 14b. The special network input layers 14a or 14b are connected to the boundary layer 13 by means of connections 6. An intermediate signal present at the boundary layer 13 can be transmitted via these connections 6 to the special network input layers 14a, 14b. The special networks 12a and 12b are each designed to evaluate the intermediate signal by means of and/or on the basis of their special purpose. Performing the evaluation on the basis of the special purpose is done in each case by means of their own neural network.

The special networks 12a, 12b each comprise a special network output layer 15a, or 15b. The special network output layers 15a, 15b are used to output probabilities in relation to their evaluated purpose, in this case the special purpose. The special network 12a, for example, outputs the probabilities P¹₁, P¹₂, P¹₃, P¹₄, while the special network 12b outputs the probabilities P²₁, P²₂.

A basic evaluation of the input signal 7 can take place by means of this neural network 1 on the basis of the base network 11, wherein the base network 11 supplies an intermediate signal, and this intermediate signal is further processed by independent special networks 12a and 12b, in particular aimed at different purposes and/or evaluations.

FIG. 4a shows a camera 16 by way of example. The camera 16 is designed as a video and/or surveillance camera. A region under surveillance 17 is monitored over video and/or can be monitored using the camera 16. The camera 16 comprises an image sensor 18, while the image sensor 18 provides images 8 as an input signal 2 to a computing unit 19. The camera 16 further comprises a storage medium 20. Commands which, when executed, perform a method are stored on the storage medium 20. This method provides for the processing of the input signal 2 by means of a neural network 1. This processing takes place, in particular, in the computing unit 19. The input signal 2 is processed in the computing unit 19 by means of the base network 11 into the intermediate signal, and this is analyzed and/or evaluated by the special networks 12a, 12b and 12c. The output of these special networks 12a to 12c leads to the output of the special network output signals 21a, 21b and 21c. The special network output signals 21a to 21c can each comprise and/or consist of probabilities relating to features or evaluations. The special network output signals 21a to 21c can become or be provided to the outside as a camera output 22.

FIG. 4b shows an embodiment of the camera 16. The camera 16 is largely designed like the camera 16 of FIG. 4a, although in contrast here, the evaluation of the input signal 2 only takes place by means of the base network 11 in the computing unit 19 in the camera. The intermediate signal is thus placed at the camera output 22, and can be accessed there. The quantity of data in the intermediate signal is in particular reduced in comparison with the input signal 2.

The intermediate signal is provided by the interface 22 to a cloud computer 23. The evaluations of the intermediate signal by means of the special networks 12a and 12b are then carried out in the cloud computer 23. This embodiment is based on the idea of outsourcing part of the computing power to the cloud computer 23, wherein at the same time lower data flows need to be transmitted from the camera 16 to the cloud computer 23, since the intermediate signal has less data than the input signal 2.

1. An evaluation device for evaluating an input signal (7), the evaluation device comprising
a base network (11), wherein the base network (11) is based on a machine learning system, and comprises an input layer (2) and a boundary layer (13), wherein a plurality of layers (4) are arranged between the input layer (2) and the boundary layer (13), and are connected by means of connections (6),
wherein the base network (11) is trained for a basic purpose,
at least two special networks (12, 12a-12b), wherein the special networks (12, 12a-12b) each comprise a special network input layer (14a, 14b) and a special network output layer (15a, 15b),
wherein the special networks (12, 12a-12b) are each trained and/or trainable for a special-purpose,
at least one computing unit (19) and at least one machine-readable storage medium (20), on which commands are stored which, when executed by the at least one computing unit (19), cause the computing unit 19 to:
receive the input signal (7) and supply it to the input layer (2),
determine an intermediate signal with the base network (11) and provide it at the boundary layer (13),
wherein the intermediate signal is provided to the at least two special networks (12, 12a-12b) at each of the special network input layers (14a, 14b),
take the intermediate signal from the special network input layers (14a, 14b) of the at least two special networks (12, 12a-12b), and
determine in each case a special network output signal on the basis of the intermediate signal with the at least two special networks (12, 12a-12b) and provide it at the special network output layer (15a, 15b).

2. The evaluation device as claimed in claim 1, wherein the determination of the special output signals takes place simultaneously by means of the at least two special networks (12, 12a-12b).

3. The evaluation device as claimed in claim 1, wherein the base network (11) forms a pruned neural network and is based on an unpruned original network, wherein the unpruned original network comprises the input layer (2) and an original network output layer with layers lying between them, wherein the boundary layer (13) is formed by one of the layers between the input layer (2) and the original network output layer.

4. The evaluation device as claimed in claim 1, further comprising at least one supplementary network, wherein the supplementary network comprises a supplementary network input layer and a supplementary network output layer, wherein the supplementary network input layer is provided with at least one special network output signal, wherein the execution of the commands stored on the at least one storage medium (20) by the at least one computing unit (19) has the effect that a supplementary network output signal is determined from the supplementary network on the basis of the special network output signal.

5. The evaluation device as claimed in claim 1, wherein in one of the special networks (12, 12a-12b) the special network output layer (15a, 15b) forms the special network input layer (14a, 14b).

6. The evaluation device as claimed in claim 1, wherein a plurality of special networks (12, 12a-12b) is stored as an application on at least one of the storage media (20), wherein a user can select special networks (12, 12a-12b) from the applications as selected special networks (12, 12a-12b), wherein the execution of the commands stored on the at least one storage medium (20) by the at least one computing unit (19) has the effect that the method is carried out with the selected special networks (12, 12a-12b).

7. The evaluation device as claimed in claim 1, wherein a first and a second computing unit (19), wherein the first computing unit (19) is designed to effectuate the steps of the method for the base network (11), while the second computing unit (19, 23) is designed to effectuate the steps of the method of at least one of the special networks (12, 12a-12b).

8. (canceled)

9. The evaluation device as claimed in claim 1, wherein the intermediate signal has a lower quantity of data than the input signal (7).

10. The evaluation device as claimed in claim 1, characterized in that the intermediate signal comprises extracted features based on the input signal (7).

11. The evaluation device as claimed in claim 1, wherein the input signal (7) comprises an image (8) and/or forms an image file.

12. The evaluation device as claimed in claim 1, wherein at least one of the special purposes comprises face recognition.

13. The evaluation device as claimed in claim 1, wherein the special purposes and/or special networks (12, 12a-12b) have different designs.

14. A camera (16) comprising the evaluation device as claimed in claim 1, characterized in that the camera (16) is designed to record images (8) of a region under surveillance, wherein the evaluation device is designed to evaluate the images (8) with the special purposes and/or the special networks (12, 12a-12b) simultaneously.

15. A method for evaluating an input signal (7),
wherein a base network (11) based on a machine learning system provides an intermediate signal to a boundary layer (13) of the base network (11) depending on the input signal (7), wherein the base network (11) is trained for a basic purpose,
wherein the intermediate signal is provided to at least two special networks (12, 12a-12b) based on a machine learning system, in each case to a special network input layer (14a, 14b),
wherein the special networks (12, 12a-12b) are each trained and/or trainable for a special purpose,
wherein in each case a special network output signal is determined using the at least two special networks (12, 12a-12b) on the basis of the intermediate signal, wherein the special network output signals are provided at the respective special network output layer (15a, 15b).

16. (canceled)

17. A non-transitory, machine-readable storage medium, containing instructions that when executed by a computer cause the computer to receive an input signal (7) and supply it to an input layer (2) of a base network (11) that is based on a machine learning system and that also includes a boundary layer (13) and a plurality of layers (4) arranged between the input layer (2) and the boundary layer (13) that are connected by connections (6), wherein the base network (11) is trained for a basic purpose,
determine an intermediate signal with the base network (11) and provide it at the boundary layer (13),
wherein the intermediate signal is provided to at least two special networks (12, 12a-12b), wherein the special networks (12, 12a-12b) each comprise a special network input layer (14a, 14b) and a special network output layer (15a, 15b),
wherein the special networks (12, 12a-12b) are each trained and/or trainable for a special-purpose,
take the intermediate signal from the special network input layers (14a, 14b) of the at least two special networks (12, 12a-12b), and
determine in each case a special network output signal on the basis of the intermediate signal with the at least two special networks (12, 12a-12b) and provide it at the special network output layer (15a, 15b).
